(19) United States
(12) Patent Application Publication
(10) Pub. No.: US 2025/0227358 A1
(43) Pub. Date: Jul. 10, 2025

(54) IMAGE PROCESSING METHOD, TERMINAL DEVICE, AND STORAGE MEDIUM

(71) Applicant: SHENZHEN ZOLON TECHNOLOGY CO., LTD., Shenzhen (CN)

(72) Inventor: GENGXIN WU, Shenzhen (CN)

(21) Appl. No.: 18/851,153

(22) PCT Filed: Mar. 21, 2023
(86) PCT No.: PCT/CN2023/082831

§ 371 Date: Sep. 26, 2024

(30) Foreign Application Priority Data
Apr. 6, 2022 (CN) 202210355544.4

(51) Int. Cl. H04N 23/63; H04N 23/81

(52) U.S. Cl. CPC H04N 23/632; H04N 23/81

(57) ABSTRACT

The present application provides an image processing method, a terminal device, and a storage medium. The method includes: storing original image data captured by a camera into a first off-screen buffer using a first terminal device, and obtaining first image data; performing an image rendering processing by invoking the first image data into a rendering process and an encoding process using the first terminal device, after obtaining a first image and a second image, displaying the first image on a terminal screen of the first terminal device in a widget preview mode; and sending the second image to a second terminal device by using the first terminal device, thereby ensuring an independence between the first image displayed on the first terminal device and the second image sent to the second terminal device, and an quality of the image output by the second terminal device.

This application claims a priority of a Chinese Patent Application with an application No. 202210355544.4 filed with the China National Intellectual Property Administration on Apr. 6, 2022, the entire contents of which are incorporated by reference in the present application.

### FIELD

The present application relates to an image processing field, particularly to an image processing method, a terminal device and a storage medium.

### BACKGROUND

In an interconnected device management network, any one of a plurality of terminal devices in a same local area network, is able to invoke a hardware device of another terminal device, use functions of the hardware device and feedback results to a terminal device that invoked the hardware device, realizing interconnection and interoperability between the plurality of terminal devices.

However, when the invoked hardware device is a camera, if a user adjusts a preview image on a side of a terminal device whose camera is invoked, it may cause changing of a final output image on a side of a terminal device that invokes the camera, a quality of an output image is not high.

### SUMMARY

### Technical Problem

Embodiments of the present application provide an image processing method, a device, a terminal device and a storage medium, which can improve effectiveness and robustness of an image processing, when a first terminal device operates on a first image, a quality of output images of a second terminal device is not affected.

### Technical Solutions

In a first aspect, the present application provides an image processing method, which includes:

storing original image data captured by a camera of a first terminal device into a first off-screen buffer using the first terminal device, and obtaining first image data; performing an image rendering processing by invoking the first image data into a rendering process and an encoding process using the first terminal device, obtaining a first image and a second image, the first image representing an image obtained after performing the image rendering processing on the first image data by the rendering process, the second image representing an image obtained after performing the image rendering processing on the first image data by the encoding process, and user operations performed on the first image and the second image being independent; displaying the first image on a terminal screen of the first terminal device in a widget preview mode; sending the second image to a second terminal device by using the first terminal device, the second terminal device being a terminal device that initiates an invocation request of a hardware device to the first terminal device.

In the embodiment of the present application, the first terminal device stores the original image captured by the camera in the first off-screen buffer, and then invokes the first image in the first off-screen buffer to the rendering process and encoding process for image rendering process, thereby ensuring the independence between the first image displayed on the first terminal device and the second image sent to the second terminal device. When the first terminal device operates the first image, the quality of output image of the second terminal device is not affected, which is able to improve the effectiveness and robustness of image processing.

In an optional method provided by the first aspect, the first terminal device performs an image rendering processing by invoking the first image data into a rendering process and an encoding process, and obtains a first image and a second image, includes:
creating a second off-screen buffer in the rendering process by the first terminal device;
storing the first image data into the second off-screen buffer by the first terminal device, and obtaining second image data;
performing an image rendering processing on the second image data by the rendering process using the first terminal device, and obtaining the first image.

In another optional method provided by the first aspect, the first terminal device performs an image rendering processing by invoking the first image data into a rendering process and an encoding process, obtains a first image and a second image, including:
the first terminal device adds third image data in the encoding process the third image data is image data other than image data that collected by the camera of the first terminal device;
the first terminal device performs the image rendering processing on the first image data and the third image data by the encoding process, and obtains the second image.

In another optional method provided in the first aspect, the first terminal device performs an image rendering processing by invoking the first image data into a rendering process and an encoding process, obtains a first image and a second image, includes:
the first terminal device stores the third image data into the second off-screen buffer;
correspondingly, the first terminal device obtains the first image by performing the image rendering processing on the second image data by the rendering process, includes:
the first terminal device obtains the first image by performing the image rendering processing on the second image data and the third image data by the rendering process.

In another optional method provided in the first aspect, the first terminal device performs an image rendering processing by invoking the first image data into a rendering process and an encoding process, obtains a first image and a second image, includes:
the first terminal device receives an image operation instruction input by a user;
the first terminal device executes the image operation instruction by the rendering process, and performing corresponding operations on an image of the first image, and obtains a third image;
correspondingly, the first terminal displays the first image on the terminal screen in the widget preview mode, includes:
the first terminal device displays the third image on the terminal screen in the widget preview mode.

In a second aspect, the present application provides an image processing device, the image processing device is applied to a first terminal device, the device includes:
a first image data storage unit, used for storing original image data captured by a camera into a first off-screen buffer, and obtaining first image data;
an image rendering processing unit, used for performing an image rendering processing by invoking the first image data into a rendering process and an encoding process using the first terminal device, obtaining a first image and a second image, the first image representing an image obtained after performing the image rendering processing on the first image data by the rendering process, the second image representing an image obtained after performing the image rendering processing on the first image data by the encoding process, and user operations performed on the first image and the second image being independent;
an image display unit, used for displaying the first image on a terminal screen of the first terminal device in a widget preview mode;
an image sending unit, used for sending the second image to a second terminal device by using the first terminal device, the second terminal device being a terminal device that initiates an invocation request of a hardware device to the first terminal device.

In an optional method provided in the second aspect, the image rendering processing unit, includes:
the first terminal device creates a second off-screen buffer in the rendering process;
the first terminal device stores the first image data into the second off-screen buffer, and obtains second image data;
the first terminal device performs an image rendering processing on the second image data by the rendering process, and obtains the first image.

In another optional method provided in the second aspect, the image rendering processing unit, includes:
an image data addition subunit, used for adding third image data in the encoding process by the first terminal device, the third image data being image data other than image data that collected by the camera of the first terminal device;
an image rendering subunit, used for performing the image rendering processing on the first image data and the third image data by the encoding process, and obtaining the second image.

In another optional method provided in the second aspect, the image rendering processing unit also includes:
An image data storage subunit, used for storing the third image data into the second off-screen buffer;
performing an image rendering processing on the third image data by the rendering process, and obtaining the first image.

In another optional method provided in the second aspect, the image rendering processing unit further comprising:
an image operation instruction receiving subunit, used for receiving image operation instruction input by a user;
an image operation instruction execution subunit, used for executing the image operation instruction performing corresponding operations on the first image for the rendering process, obtaining the third image, and display the third image on a terminal screen in a widget preview mode.

In a third aspect, the present application provides an image processing terminal device includes: a storage device; at least one processor; computer program stored by the storage device, wherein the image processing method according to the first aspect or any method of the first aspect being implemented when the computer program being executed by the processor.

In a fourth aspect, the present application provides a non-transitory computer-readable storage medium, the non-transitory computer-readable storage medium store computer program, wherein the image processing method according to the first aspect or any method of the first aspect being implemented when the computer program being executed by a processor.

In a fifth aspect, embodiments of the present application provide a computer program product, when the computer program product is run on an image processing device, causes executing the steps of the image processing method in the first aspect by the image processing device.

It can be understood that the beneficial effects of the second aspect to the fifth aspect can be referred to the relevant description in the first aspect, and will not be described again here.

### BRIEF DESCRIPTION OF THE DRAWINGS

To more clearly illustrate the technical solutions in the embodiments of the present application, the drawings needed to be used in the embodiments or description of the prior art will be briefly introduced below. Obviously, the drawings in the following description are merely for the purpose of the present application. In some embodiments, for ordinary person skilled in the art, other drawings can be obtained based on these drawings without exerting creative efforts.

FIG. 1 is a schematic flow chart of an image processing method provided by an embodiment of the present application;

FIG. 2 is a schematic flow chart of another image processing method provided by an embodiment of the present application;

FIG. 3 is a schematic flow chart of another image processing method provided by an embodiment of the present application;

FIG. 4 is a schematic structural diagram of an image processing device provided by an embodiment of the present application;

FIG. 5 is a schematic structural diagram of an image processing terminal device provided by an embodiment of the present application.

### DETAILED DESCRIPTION

In the following description, for the purpose of explanation rather than limitation, specific details such as specific system structures and technologies are provided to provide a thorough understanding of the embodiments of the present application. However, it will be apparent to those skilled in the art that the present application may be practiced in other embodiments without these specific details. In other instances, detailed descriptions of well-known systems, devices, circuits, and methods are omitted so as not to obscure the description of the present application with unnecessary detail.

It will be understood that the term “and/or” as used in this specification and the appended claims refers to and includes any and all possible combinations of one or more of the associated listed items. In addition, in the description of this application and the appended claims, the terms “first”, “second”, “third”, etc. are merely used to distinguish the description, and cannot be understood as indicating or implying relative importance.

It will also be understood that reference in the specification to “one embodiment” or “some embodiments” or the like means that a particular feature, structure or characteristic described in connection with the embodiment is included in one or more embodiments of the application. Therefore, the phrases “in one embodiment”, “in some embodiments”, “in other embodiments”, “in another embodiments”, etc. appearing in different places in this specification are not necessarily references made to the same embodiment, but rather to “one or more but not all embodiments” unless specifically stated otherwise. The terms “including,” “containing,” “having,” and variations thereof all mean “including but not limited to,” unless otherwise specifically emphasized.

Before describing the image processing method provided by the embodiment of the present application, first, an exemplary description of the application scenarios involved in the embodiment of the present application is provided.

In an interconnected device management network, terminal devices with the same system in a same Local Area Network (LAN), such as ANDROID™ terminal devices, form a new LAN. Terminal devices in the new LAN can share part of their own hardware device, such as camera, through user authorization. When an Android terminal device (hereinafter referred to as POS_A) obtains an authorization to use a camera of another Android terminal device (hereinafter referred to as POS_B), POS_A can request POS_B to active its designated camera (such as front camera, a rear camera) when the POS_A has business needs, by using OpenGL ES customized display controls, the POS_B can send the customized display controls to the POS_A in a predetermined format such as H264 through the network.

However, in actual applications, because the POS_B may performs other operations, important content may be displayed on a terminal screen of the POS_B or other human-computer interactions are taking place, if a preview window of the camera pops up directly at this time, it may affect the current operation to the POS_B, and it is not friendly for users of the POS_B. However, without popping up the preview window of the camera, POS_B cannot be notified, it may violate POS_B's privacy. In this scenario, POS_B needs to adjust a size of the display control to achieve the purpose of hiding the control without affecting the current screen. At the same time, in order to avoid a problem that when POS_B adjusts the size of the display control, the image returned to POS_A will also be adjusted accordingly, resulting in uncontrollable image quality output by POS_A. Based on this, the embodiments of the present application provide an image processing method to solve the problem. The above problems prevent POS_B from affecting the image output quality of POS_A when operating a display control on the POS_B.

The image processing method provided by this application is illustratively described below according to embodiments.

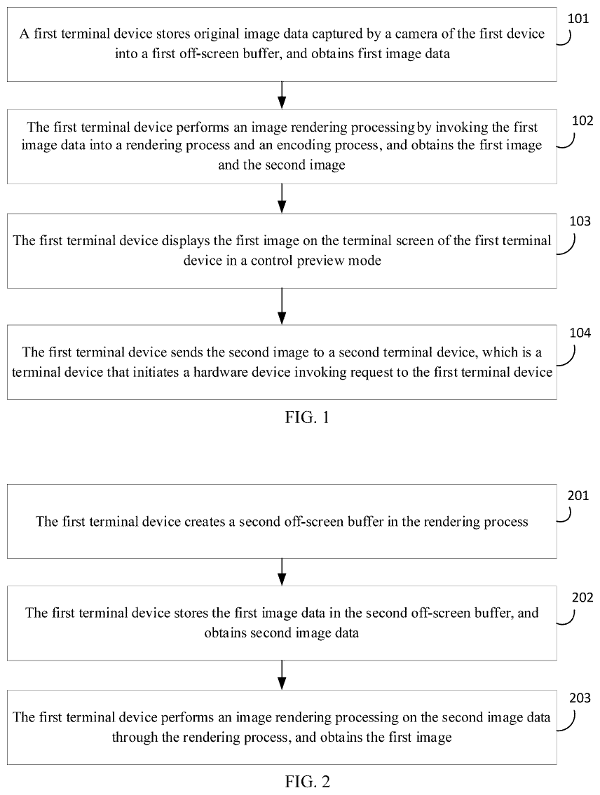

Please refer to FIG. 1. FIG. 1 is a schematic flow chart of an image processing method provided by an embodiment of the present application. The details are described as follows:
Step S101: the first terminal device stores original image data captured by a camera of the first device into a first off-screen buffer, and obtains first image data.

In this embodiment of the present application, after receiving a hardware device invoking request sent by a second terminal device, the first terminal device parses the hardware device invoking request, determines the hardware device to be invoked by the second terminal device, and launches the hardware device. When the hardware device that the second terminal device needs to invoke is the camera of the first terminal device, the camera of the first terminal device is started to capture original image data, and the captured original image data is stored into a first off-screen buffer created by the first terminal device, to achieve the purpose of image data sharing.

It needs to be noted that for converting the original image data captured by the camera into image data that can be displayed on the screen of the terminal device, the data format of the original image data needs to be converted into a data format supported by the screen of the terminal device. For example, the image data captured by the camera can be YUV data, and the image data supported by the screen of the terminal device is red green blue (RGB) data, it requires image rendering processing of the image data captured by the camera, implementing conversion of the image data through texture mapping.

In some embodiments of the present application, after the first terminal device receives the hardware device invoke request sent by the second terminal device and determining the hardware device to be invoked by the second terminal device, the first terminal device creates an OpenGL ES extended texture, creates a preview control SurfaceTexture using the extended texture, for using the preview widget SurfaceTexture as the carrier of the camera preview data. At the same time, the first terminal device creates a first off-screen buffer and binds the first off-screen buffer to the extended texture, the original image data captured by the camera can be shared to the first off-screen buffer, for facilitating the rendering process and encoding process to invoke the image data stored in the first off-screen buffer.
Step S102: the first terminal device performs an image rendering processing invoking the first image data into the rendering process and the encoding process, and obtains the first image and the second image.

In this embodiment of the present application, the first image representing an image obtained after performing the image rendering processing on the first image data by the rendering process, the second image represents an image obtained after performing the image rendering processing on the first image data by the encoding process, and user operations performed on the first image and the second image are independent, the second image is not affected by a user's related operations on the first image on the first terminal device. For example, when the user performs operations such as scaling, cropping, and rotating the first image on the screen of the first terminal device, the second image displayed on the screen of the second terminal device is not affected by the user's operation.

Specifically, when the user holds the first terminal device and performs operations such as scaling, cropping, rotating, etc. on the first image on the screen of the first terminal device, merely the image obtained after the rendering process executed by the user is displayed on the screen of the first terminal device. At the same time, the second image displayed on the screen of the second terminal device is not affected by the user's operation, and the pixel size of the image is not changed.

In some embodiments of the present application, since the user of the first terminal device needs to adjust the display size of the preview widget, the image data corresponding to the preview widget is also changed. To avoid the problem that the second image output by the second terminal device is changed caused by the changes of image data, another off-screen buffer is created in the rendering process for avoiding damage to the original image data.

Please refer to FIG. 2. FIG. 2 is a schematic flow chart of another image processing method provided by an embodiment of the present application. The details are described as follows:
Step S201: the first terminal device creates a second off-screen buffer in the rendering process.
Step S202: the first terminal device stores the first image data in the second off-screen buffer, and obtains second image data.
Step S203, the first terminal device performs image rendering processing on the second image data through the rendering process, and obtains the first image.

In this embodiment of the present application, the first terminal device creates a second off-screen buffer in the rendering process, stores the invoked first image data into the second off-screen buffer and obtains the second image, before invoking the first image data to the rendering process. At this moment, the second image data in the second off-screen buffer is the same as the first image data in the first off-screen buffer, and image data formats are also the same, that is, the original image data collected by the camera, maps the second image data to the texture for rendering through the rendering process, and the image data format of the second image data is converted into RGB format supported by the screen and stored in a texture buffer for displaying on a screen. The first image is displayed on the screen of the first terminal device.

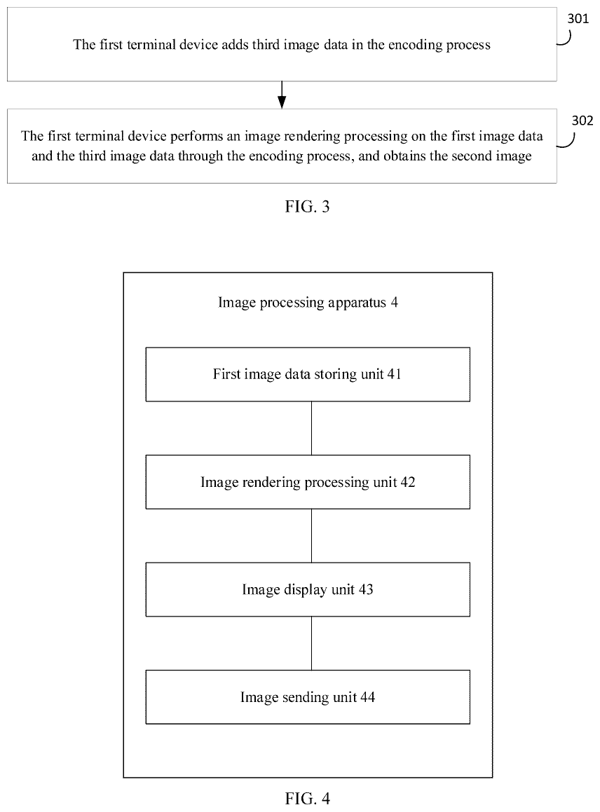

Please refer to FIG. 3. FIG. 3 is a schematic flow chart of another image processing method provided by an embodiment of the present application. The details are described as follows:
Step S301: the first terminal device adds a third image data in the encoding process.

In the embodiment of the present application, the third image data is a image data other than the image data collected by the camera of the first terminal device. For example, the third image data can be built-in watermark data of the system or any image data other than the image data collected by the camera of the first terminal device, such as date watermarks, address watermarks, terminal device model watermarks, etc., it is not specifically limited here.
Step S302: the first terminal device performs the image rendering processing on the first image data and the third image data through the encoding process, and obtains the second image.

In this embodiment of the present application, the third image data could be the watermark data of the first terminal device or the watermark data of the second terminal device, it is not specifically limited here.

After the user adds the watermark data, the first terminal device maps the watermark data and the first image data obtained from the first off-screen buffer into the texture through the encoding process for rendering, sends the obtained image data from rendering, which is the second image, to a H264 data interface, by using an H264 encoder, and sends the second image to the second terminal device through the H264 data interface.

At the same time, in order to ensure that the first image and the second image displayed on the first terminal device are consistent, the first terminal device stores the third image data in the second off-screen buffer; and performs the image rendering processing on the second image data and the third image data in the second off-screen buffer, and obtains the first image including watermark data.
Step S103: the first terminal device displays the first image on the terminal screen of the first terminal device in a control preview mode.

In this embodiment of the present application, when the first terminal device held by the user displays the first image in a control preview mode on the screen of the first terminal device, in order to avoid affecting current screen operations, the user can adjust the display controls to achieve the purpose of hiding the display control. At this time, when the first terminal device receives the image operation instruction input by the user, the first terminal device executes the above image operation instruction through the rendering process, performs corresponding operations on the first image, and obtains the third image; and displays the third image on the terminal screen in a control preview mode.
Step S104: the first terminal device sends the second image to the second terminal device. The second terminal device is a terminal device that initiates a hardware device invoking request to the first terminal device.

In this embodiment of the present application, the first terminal device encodes the image data obtained during the encoding process through an H264 encoder to obtain a second image, and sends the second image to the second terminal device through the H264 data interface. The second image and the first images obtained by the rendering process are independent of each other, and is not affected by the user's operations on the first image. Size specifications of the second image finally sent to the second terminal device can be set on the side of the first terminal device, or the size specification of the second image can be set on the second terminal device, it is not specifically limited here.

In this embodiment of the present application, the first terminal device stores the original image data collected by the camera in the first off-screen buffer, and invokes the first image data in the first off-screen buffer to the rendering process and encoding process for image rendering process, thereby, ensuring the independence between the first image displayed on the first terminal device and the second image sent to the second terminal device. When operating on the first image using the first terminal device, it does not affect the image output quality of the second terminal device, and the effectiveness and robustness of image processing is improved.

It should be understood that a sequence number of each step in the embodiment does not mean the execution order. The execution order of each process should be determined by its function and internal logic, and should not constitute any limitation on the implementation process of the embodiment of the present application.

Based on the image processing method provided by the embodiments, the embodiments of this application further provide device embodiments for implementing the above method embodiments.

Please refer to FIG. 4. FIG. 4 is a schematic diagram of an image processing device provided by an embodiment of the present application. Each included unit can be used to execute each step in the embodiment corresponding to FIG. 1. For details, please refer to the relevant descriptions in the embodiments corresponding to FIG. 1. For convenience of explanation, merely parts related to this embodiment are shown. Referring to FIG. 4, the image processing apparatus 4 includes:
the first image data storage unit 41, which is configured to store the original image data collected by the camera of the first terminal device into the first off-screen buffer, and obtain the first image data;
the image rendering processing unit 42, which is configured to invoke the first image data into the rendering process and the encoding process to perform an image rendering processing, and obtain the first image and the second image. The first image is an image obtained after performing the rendering processing on the first image data by the rendering process, the second image is an image obtained after performing the rendering processing on the first image data by the encoding process. The user operations between the first image and the second image are independent of each other;
the image display unit 43, which is configured to display the first image on the terminal screen of the first terminal device in a control preview mode;
the image sending unit 44, which is configured to send the second image to a second terminal device. The second terminal device is a terminal device that initiates a hardware device invoking request to the first terminal device.

Specifically, in some embodiments of the present application, the image rendering processing unit 42 includes:
the first terminal device, which creates a second off-screen buffer in the rendering process;
the first terminal device, which stores the first image data into the second off-screen buffer, and obtains the second image data;
the first terminal device, which performs image rendering processing on the second image data through the rendering process, and obtains the first image.

Specifically, in other embodiments of the present application, the image rendering processing unit 42 includes:
an image data adding subunit, which is configured to add the third image data in the encoding process, the third image data is image data other than the image data collected by the camera of the first terminal device;
an image rendering subunit, which is configured to perform image rendering processing on the first image data and the third image data through the encoding process, and obtain the second image.

Specifically, in other embodiments of the present application, the image rendering processing unit 42 also includes:
an image data storage subunit, which is configured to store the third image data in the second off-screen buffer;
the first image is obtained by performing the image rendering processing on the second image data and the third image data through the rendering process.

Specifically, in other embodiments of the present application, the image rendering processing unit 42 also includes:
the image operation instruction receiving subunit, which is configured to receive the image operation instruction input by the user;
the image operation instruction execution subunit, which is configured to invoke the rendering process to execute the image operation instruction, perform corresponding operations on the image of the first image, obtain the third image, and display the third image on the terminal screen in a control preview mode.

In this embodiment of the present application, the first terminal device stores the original image data collected by the camera in the first off-screen buffer, and invokes the first image data in the first off-screen buffer to perform the image rendering processing by the rendering process and encoding process, ensuring the independence between the first image displayed on the first terminal device and the second image sent to the second terminal device. When the first terminal device operates on the first image, it does not affect the image output quality of the second terminal device, and the effectiveness and robustness of image processing is improved.

It should be noted that the information interaction, execution process, etc. between the modules are based on the same concept as the method embodiments of this application. For details of their specific functions and technical effects, please refer to the method embodiments section, which will not be discussed here.

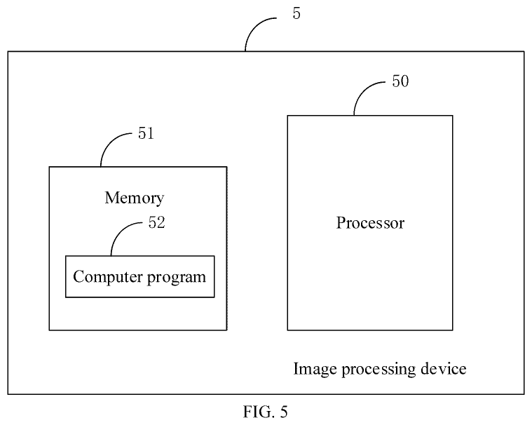

FIG. 5 is a schematic diagram of an image processing terminal device provided by an embodiment of the present application. As shown in FIG. 5, an image processing terminal device 5 of this embodiment includes: a processor 50, a memory 51, and a computer program 52 stored in the memory 51 and executable on the processor 50, such as a speech recognition program. When the processor 50 executes the computer program 52, it implements the steps in each of the above image processing method embodiments, such as steps 101-104 shown in FIG. 1. Alternatively, when the processor 50 executes the computer program 52, it implements the functions of each module/unit in each of the device embodiments, such as the functions of the units 41-44 shown in FIG. 4.

For example, the computer program 52 can be divided into one or more modules/units, and one or more modules/units are stored in the memory 51 and executed by the processor 50 to complete the present application. One or more modules/units may be a series of computer program instruction segments capable of completing specific functions. The instruction segments are used to describe the execution process of the computer program 52 in the image processing terminal device 5. For example, the computer program 52 can be divided into a first image data storage unit 41, an image rendering processing unit 42, an image display unit 43, and an image sending unit 44. For the specific functions of each unit, please refer to the relevant descriptions in the corresponding embodiment of FIG. 1. No further details will be given here.

The image processing device may include, but is not limited to, a processor 50 and a memory 51. Those skilled in the art can understand that FIG. 5 is merely an example of the image processing terminal device 5 and does not constitute a limitation on the image processing terminal device 5. It may include more or fewer components than shown, or some components may be combined or different. For example, image processing devices may also include input and output devices, network access devices, buses, etc.

The processor 50 can be a central processing unit (CPU), or other general-purpose processor, a digital signal processor (Digital Signal Processor, DSP), an application specific integrated circuit (Application Specific Integrated Circuit, ASIC), Ready-made field-programmable gate array (FPGA) or other programmable logic devices, discrete gate or transistor logic devices, discrete hardware components, etc. A general-purpose processor may be a micro-processor or the processor may be any conventional processor, etc.

The memory 51 may be an internal storage unit of the image processing terminal device 5, such as a hard disk or a memory of the image processing terminal device 5. The memory 51 can also be an external storage device of the image processing terminal device 5, such as a plug-in hard disk, a smart memory card (Smart Media Card, SMC), a secure digital (SD) card, or a flash memory card equipped on the image processing terminal device 5 (Flash Card) etc. Further, the memory 51 may also include both an internal storage unit of the image processing terminal device 5 and an external storage device. The memory 51 is used to store computer programs and other programs and data required by the image processing terminal device. The memory 51 can also be used to temporarily store data that has been output or is to be output.

Embodiments of the present application also provide a non-transitory computer-readable storage medium. The non-transitory computer-readable storage medium stores a computer program. When the computer program is executed by a processor, the above image processing method can be implemented.

Embodiments of the present application provide a computer program product. When the computer program product is run on an image processing device, the image processing method can be implemented when the image processing device executes it.

Those skilled in the art can clearly understand that for the convenience and simplicity of description, merely the division of the above functional units and modules is used as an example. In actual applications, the above functions can be allocated to different functional units and modules according to needs. Module completion means dividing the internal structure of the device into different functional units or modules to complete all or part of the functions described above. Each functional unit and module in the embodiment can be integrated into one processing unit, or each unit can exist physically alone, or two or more units can be integrated into one unit. The integrated unit can be hardware-based. It can also be implemented in the form of software functional units. In addition, the specific names of each functional unit and module are merely for the convenience of distinguishing each other and are not used to limit the scope of protection of the present application. For the specific working processes of the units and modules in the above system, please refer to the corresponding processes in the foregoing method embodiments, and will not be described again here.

In the above embodiments, each embodiment is described with its own emphasis. For parts that are not detailed or documented in a certain embodiment, please refer to the relevant descriptions of other embodiments.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of this application.

The embodiments are merely used to illustrate the technical solutions of the present application, but not to limit them; although the present application has been described in detail with reference to the foregoing embodiments, those of ordinary skill in the art should understand that they can still implement the implementations. The technical solutions described in the examples are modified, or some of the technical features are equivalently replaced; and these modifications or substitutions do not cause the essence of the corresponding technical solutions to deviate from the spirit and scope of the technical solutions in the embodiments of this application, and should be included in within the protection scope of this application.

1. An image processing method, comprising:
storing original image data captured by a camera of a first terminal device into a first off-screen buffer using the first terminal device, and obtaining first image data;
performing an image rendering processing by invoking the first image data into a rendering process and an encoding process using the first terminal device, obtaining a first image and a second image, the first image representing an image obtained after performing the image rendering processing on the first image data by the rendering process, the second image representing an image obtained after performing the image rendering processing on the first image data by the encoding process, and user operations performed on the first image and the second image being independent;
displaying the first image on a terminal screen of the first terminal device in a widget preview mode;
sending the second image to a second terminal device by using the first terminal device, the second terminal device being a terminal device that initiates an invocation request of a hardware device to the first terminal device.

2. The image processing method according to claim 1, wherein performing an image rendering processing by invoking the first image data into a rendering process and an encoding process using the first terminal device, obtaining a first image and a second image comprises:
creating a second off-screen buffer in the rendering process by the first terminal device;
storing the first image data into the second off-screen buffer by the first terminal device, and obtaining second image data;
performing an image rendering processing on the second image data by the rendering process using the first terminal device, and obtaining the first image.

3. The image processing method according to claim 2, wherein performing an image rendering processing by invoking the first image data into a rendering process and an encoding process using the first terminal device, obtaining a first image and a second image, further comprises:
adding third image data in the encoding process by the first terminal device, the third image data being image data other than image data that collected by the camera of the first terminal device;
performing the image rendering processing on the first image data and the third image data by the encoding process, and obtaining the second image.

4. The image processing method according to claim 3, wherein performing an image rendering processing by invoking the first image data into a rendering process and an encoding process using the first terminal device, obtaining a first image and a second image, further comprises:
storing the third image data into the second off-screen buffer by the first terminal device;
correspondingly, obtaining the first image by performing the image rendering processing on the second image data by the rendering process using the first terminal device, comprises:
obtaining the first image, using the first terminal device, by performing the image rendering processing on the second image data and the third image data by the rendering process.

5. The image processing method according to claim 1, wherein performing an image rendering processing by invoking the first image data into a rendering process and an encoding process using the first terminal device, obtaining a first image and a second image, further comprises:
receiving an image operation instruction input by a user by the first terminal device;
executing the image operation instruction by the rendering process, and performing corresponding operations on the first image by the first terminal device, and obtaining a third image;
correspondingly, displaying the first image on its terminal screen in the widget preview mode, comprises:
displaying the third image on the terminal screen of the first terminal device in the widget preview mode.

6-10. (canceled)

11. A first terminal device comprising:
a processor, a storage device, and computer programs that are stored in the storage device and can be executed by the processor, cause the processor to:
store original image data captured by a camera into a first off-screen buffer, and obtain first image data;
perform an image rendering processing by invoking the first image data into a rendering process and an encoding process, obtain a first image and a second image, the first image representing an image obtained after performing the image rendering processing on the first image data by the rendering process, the second image representing an image obtained after performing the image rendering processing on the first image data by the encoding process, and user operations performed on the first image and the second image being independent;
display the first image on a terminal screen of the first terminal device in a widget preview mode;
send the second image to a second terminal device, the second terminal device being a terminal device that initiates an invocation request of a hardware device to the first terminal device.

12. The first terminal device of claim 11, wherein the processor is further caused to:
create a second off-screen buffer in the rendering process;
store the first image data into the second off-screen buffer, and obtain second image data;
perform an image rendering processing on the second image data by the rendering process, and obtain the first image.

13. The first terminal device of claim 12, wherein the processor is further caused to:
add third image data in the encoding process, the third image data being image data other than image data that collected by the camera of the first terminal device;
perform the image rendering processing on the first image data and the third image data by the encoding process, and obtain the second image.

14. The first terminal device of claim 13, wherein the processor is further caused to:
store the third image data into the second off-screen buffer;
correspondingly, obtain the first image by performing the image rendering processing on the second image data by the rendering process, comprises:
obtaining the first image, by performing the image rendering processing on the second image data and the third image data by the rendering process.

15. The first terminal device of claim 11, wherein the processor is further caused to:
receive an image operation instruction input by a user,
execute the image operation instruction by the rendering process, and performing corresponding operations the first image, and obtain a third image;
display the third image on the terminal screen of the first terminal device in the widget preview mode.

16. A non-transitory storage medium, having stored thereon at least one computer-readable instructions, which when executed by a processor of a first terminal device, causes the processor to perform an image processing method, the image processing method comprising:
storing original image data captured by a camera into a first off-screen buffer using a first terminal device, and obtaining first image data;
performing an image rendering processing by invoking the first image data into a rendering process and an encoding process using the first terminal device, obtaining a first image and a second image, the first image representing an image obtained after performing the image rendering processing on the first image data by the rendering process, the second image representing an image obtained after performing the image rendering processing on the first image data by the encoding process, and user operations performed on the first image and the second image being independent;
displaying the first image on a terminal screen of the first terminal device in a widget preview mode;
sending the second image to a second terminal device by using the first terminal device, the second terminal device being a terminal device that initiates an invocation request of a hardware device to the first terminal device.

17. The non-transitory storage medium of claim 16, wherein performing an image rendering processing by invoking the first image data into a rendering process and an encoding process using the first terminal device, obtaining a first image and a second image comprises:
creating a second off-screen buffer in the rendering process by the first terminal device;
storing the first image data into the second off-screen buffer by the first terminal device, and obtaining second image data;
performing an image rendering processing on the second image data by the rendering process, and obtaining the first image.

18. The non-transitory storage medium of claim 17, wherein performing an image rendering processing by invoking the first image data into a rendering process and an encoding process using the first terminal device, obtaining a first image and a second image, further comprises:
adding third image data in the encoding process by the first terminal device, the third image data being image data other than image data that collected by the camera of the first terminal device;
performing the image rendering processing on the first image data and the third image data by the encoding process, and obtaining the second image.

19. The non-transitory storage medium of claim 18, wherein performing an image rendering processing by invoking the first image data into a rendering process and an encoding process using the first terminal device, obtaining a first image and a second image, further comprises:
storing the third image data into the second off-screen buffer by the first terminal device;
correspondingly, obtaining the first image by performing the image rendering processing on the second image data by the rendering process using the first terminal device, comprises:
obtaining the first image, using the first terminal device, by performing the image rendering processing on the second image data and the third image data by the rendering process.

20. The non-transitory storage medium of claim 16, wherein performing an image rendering processing by invoking the first image data into a rendering process and an encoding process using the first terminal device, obtaining a first image and a second image, further comprises:
receiving an image operation instruction input by a user by the first terminal device;
executing the image operation instruction by the rendering process, and performing corresponding operations on the first image by the first terminal device, and obtaining a third image;
correspondingly, displaying the first image on its terminal screen in the widget preview mode, comprises:
displaying the third image on the terminal screen of the first terminal device in the widget preview mode.
